(19) United States
(12) Patent Application Publication
(10) Pub. No.: US 2005/0078354 A1
(43) Pub. Date: Apr. 14, 2005

(54) Optical fiber amplifier

(76) Inventors: Sun-Hyok Chang, Daejon (KR); Jin-Soo Han, Daejon (KR); Ji-Sung Jung, Daejon (KR); Heuk Park, Deajon (KR); Won-Kyoung Lee, Busan (KR); Hyun-Jae Lee, Deajon (KR); Hee-Sang Chung, Deajon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/814,676

(22) Filed: Mar. 30, 2004

(30) Foreign Application Priority Data
Sep. 19, 2003 (KR) 2003-0065253

(51) Int. Cl. H01S 3/00

(52) U.S. Cl. 359/334

(57) ABSTRACT

Optical fiber amplifier with wide input power dynamic range is employed to make a first gain block and an optical fiber pumped by Raman pump have opposite spectral gain profiles each other, thereby obtaining flat output gain profile. The optical fiber amplifier includes: a first and a second gain blocks, wherein each gain block has a gain medium and at least one optical pump; an optical fiber disposed between the first and the second gain blocks; a Raman pump for generating a pumping light; and a coupling means for coupling the pumping light to the optical fiber.

### FIELD OF THE INVENTION

The present invention relates to an optical communication system device; and, more particularly, to an optical fiber amplifier having a wide input power dynamic range for use in a wavelength division multiplexing (WDM) optical transmission system.

### DESCRIPTION OF THE PRIOR ART

In recent years, as the Internet has been popularly utilized, it is required to increase transmission capacity more and more in an optical communication system. In order to meet the demand, a wavelength division multiplexing (WDM) optical transmission system is used for the optical communication system because it is appropriate to transmit great amount of data.

In particular, since an optical fiber amplifier such as an erbium doped fiber amplifier (EDFA) and a fiber Raman amplifier (FRA) has a broad gain bandwidth, it is usefully employed for the WDM optical communication system. Typically, the EDFA is utilized as a line amplifier in order to re-amplify attenuated optical signals after passing through a span of transmission line and to transmit the re-amplified optical signals to a next span of the transmission line. An input power of the EDFA may be changed while passing through the transmission line due to change of channel number and optical loss in the transmission line. Nevertheless, automatic control module is required for keeping constant gain or constant channel power after the optical signal passes through the EDFA.

Generally, as the input signal power of the EDFA is changed, output optical signal can have slope in gain spectrum across signal wavelength band. In order to obtain flat output gain profile, therefore, there are introduced various methods: controlling pump powers; controlling optical loss at inter-stage of the EDFA; and utilizing optical feedback.

Meanwhile, a distributed Raman amplifier (DRA) is widely used for improving transmission performance because the DRA is capable of increasing optical signal to noise ratio (OSNR) of the optical signal passing through the transmission line. That is, when the DRA is employed for optical amplification, the transmission line is pumped directly by Raman pumps so that the optical loss of the optical signal can be reduced during the optical signal passing therethrough.

However, when the DRA is introduced for the conventional WDM transmission system in which the EDFA is used as the line amplifier, the optical signal amplified at the DRA is inputted into the EDFA so that input power is too high for the automatic gain control (AGC) to be operated. That is, in this case, the input power of the optical signal is out of range where the AGC is working, i.e., out of the input power dynamic range.

Accordingly, when the DRA is used for the conventional transmission line, the EDFA should be adjusted in order for the AGC to be working in high input power range. In order to obtain flat output gain profile despite the high input power, it is necessary to develop new optical fiber amplifier applicable to a wide input power dynamic range.

Referring to FIG. 1, there is shown a schematic view of conventional optical fiber amplifier for use in the WDM optical transmission system.

In FIG. 1, after an optical signal passes through a transmission line 101, the optical signal generally experiences optical loss. Therefore, the optical signal should be re-amplified at line amplifier 102 and then, is transmitted to a next span. Herein, a denotation of 107 represents an optical signal path.

Meanwhile, the transmission line 101 may be differently structured according to a kind of an optical fiber such as a single-mode fiber (SMF), a dispersion shifted fiber (DSF) or a non-zero dispersion shifted fiber (NZ-DSF). In addition, a length of the transmission line 101 may also be changed according to total transmission distance. In general, one span of the transmission distance ranges about 80 km to 100 km in long distance transmission system, wherein the EDFA is popularly used for the line amplifier 102. The WDM optical transmission system has about 40 to about 160 transmission channels. When the all channels are transmitted simultaneously, it is preferable that total input power to the line amplifier 102 should be in a range of about −5 dBm to 0 dBm.

In the WDM optical transmission system, as aforementioned above, the DRA is employed for enhancing the transmission performance or total transmission distance. In detail, pumping lights generated from Raman pumps 105, 106 are forwardly and backwardly inputted to the transmission line 101 by using WDM couplers 103, 104, thereby obtaining Raman gain induced by the pumping lights. Herein, the Raman gain is varied as pumping power of Raman pump power is changed. Generally, Raman pumping scheme is designed for obtaining the Raman gain in the range of about 5 dB to 15 dB so that total input power range of the line amplifier 102 is increased to the range of about +5 dBm to +15 dBm. In case of not utilizing the DRA in the WDM transmission system, the line amplifier 102 can be operable within the input power ranging from about −5 dBm to about 0 dBm. Whereas, in case of employing the DRA in the WDM transmission system, the input power dynamic range is increased to the range of about +5 dBm to about +15 dBm. As a result, it is difficult to obtain the flat output gain after the optical signal passes through the line amplifier 102 due to high input power. That is, since there is limitation of the input power dynamic range in case of employing the DRA, a new EDFA is essentially required in order to be operable in the input power ranging from +5 dBm to +15 dBm, for obtaining the flat output gain profile.

### SUMMARY OF THE INVENTION

It is, therefore, an object of the present invention to provide an optical fiber amplifier which is applicable to wide input power dynamic range to obtain flat output gain profile across signal wavelength band by making a first gain block and a distributed Raman amplifier (DRA) employing optical fiber in a rear of the first gain block have opposite slopes in spectral gain profile, wherein the first gain block and the optical fiber have opposite gain profiles, to thereby offset gain characteristics each other and obtain a flat spectral gain profile.

In accordance with one aspect of the present invention, there is provided an optical fiber amplifier, including: a first and a second gain blocks, wherein each gain block has a gain medium and at least one optical pump; an optical fiber disposed between the first and the second gain blocks; a Raman pump for generating a pumping light; and a coupling means for coupling the pumping light to the optical fiber.

### BRIEF DESCRIPTION OF THE DRAWINGS

The above and other objects and features of the present invention will become apparent from the following description of the preferred embodiments given in conjunction with the accompanying drawings, in which:

FIG. 1 is a schematic view setting forth a conventional optical amplifier for use in a wavelength division multiplexing (WDM) transmission system;

FIG. 2 is a schematic view setting forth an optical amplifier in accordance with a first preferred embodiment of the present invention;

FIGS. 3A and 3B are graphs setting forth a gain flatness mechanism in accordance with the present invention;

FIG. 4 is a schematic view setting forth an optical amplifier in accordance with a second preferred embodiment of the present invention; and

FIG. 5 is a graph setting forth an output gain profile across a signal wavelength band corresponding to a various input power in accordance with the present invention.

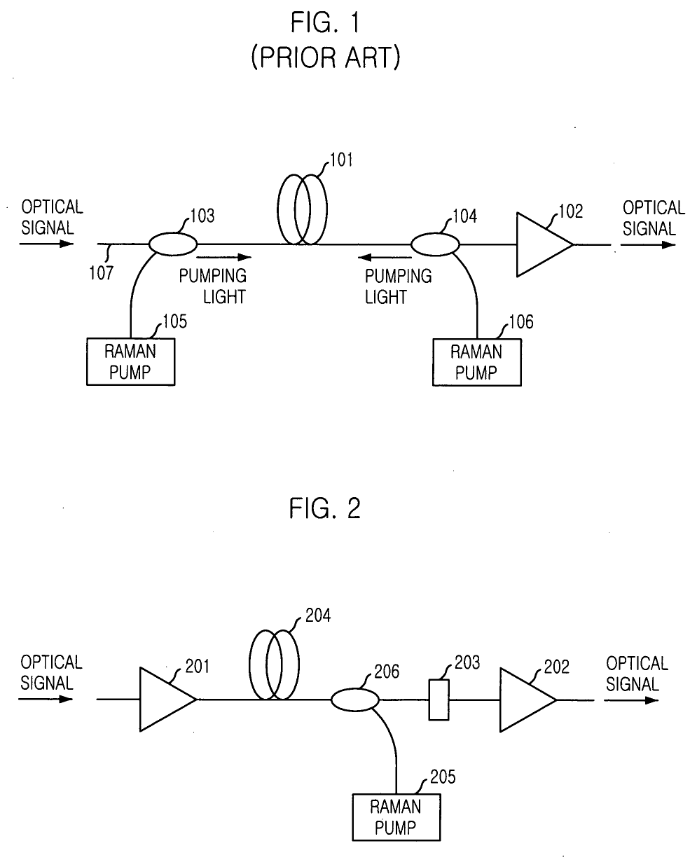

### DETAILED DESCRIPTION OF THE PREFERRED EMBODIMENTS

Referring to FIG. 2, there is shown a schematic view setting forth an optical fiber amplifier in accordance with a first preferred embodiment of the present invention.

In FIG. 2, the optical amplifier includes a first gain block 201, a second gain block 202, an optical fiber 204, a Raman pump 205 and a wavelength division multiplexing (WDM) coupler 206. Herein, each of the first and the second gain blocks 201, 202 has a gain medium and at least one pump, for amplifying inputted optical signal and generating an optical gain, wherein the gain medium employs a rare earth doped fiber or rare earth doped waveguide. The optical amplifier further includes a gain flattening filter 203 in order to flatten gain spectrum.

Between the first gain block 201 and the WDM coupler 206, there is the optical fiber 204 in which the optical signal is amplified by the pumping light generated from the Raman pump 205. Herein, the pumping light is coupled to the optical signal through the WDM coupler 206. The optical fiber 204 employs a predetermined optical medium such as a dispersion compensated fiber (DCF), a highly non-linear fiber (HNLF), a single-mode fiber (SMF) or a combination thereof, for obtaining sufficient Raman gain. Here, the gain flattening filter 203 is disposed between the WDM coupler 206 and the second gain block 202 in the first embodiment. Alternatively, the gain flattening filter 203 can be disposed at other location of light pathway for improving gain flatness in passing through the optical fiber amplifier.

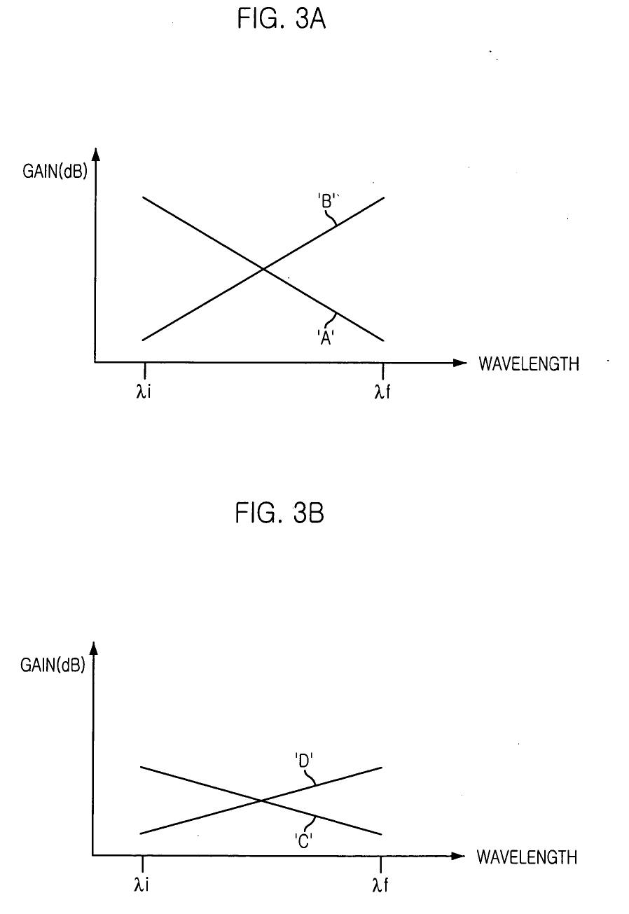

Referring to FIGS. 3A and 3B, there are shown graphs setting forth gain flatness mechanism of the optical amplifier in accordance with the present invention. Herein, denotations of λi and λf represent an initial wavelength and a final wavelength in WDM signal wavelength band, respectively.

FIG. 3A represents an output gain spectrum when the input power is low. In FIG. 3A, the first gain block 201 is designed to have a first gain slope ‘A’ versus the signal wavelength band when the input power is low, i.e., when a distributed Raman amplifier (DRA) does not applied at the transmission line. Furthermore, a Raman gain slope ‘B’ of the optical fiber 204 is conversely designed in comparison with the first gain slope ‘A’. Namely, a Raman gain has an opposite spectral gain profile to the first gain slope ‘A’ in which a peak value is disposed at the final wavelength (λf) of the signal wavelength band. Herein, the Raman gain spectrum is generally determined by the wavelength of the Raman pump 205. By designing the first gain block 201 and the optical fiber 204 having the first gain slope ‘A’ and the first Raman gain slope ‘B’ respectively, it is possible to obtain flat gain spectrum after the optical signal passes through the second gain block 202. It is noted that the configuration of the gain profile is schematically depicted as a straight line but the actual gain profile may not be straight line. In order to obtain the flat and straight gain profile, therefore, the gain flattening filter 203 is required. In the present invention, the second gain block 202 is structured in a manner that roughly flat input gain spectrum is inputted thereto and a flat output gain spectrum is outputted therefrom. Alternatively, the second gain block 202 can be designed for the output power to be high enough.

FIG. 3B represents another output gain spectrum when the input power is high. In FIG. 3B, a second gain slope ‘C’ after the optical signal passes through the first gain block 201 has a gentle one so that the gain at the same wavelength is lowered in comparison with the first gain slope ‘A’. The reason of the gentle gain slope is that the gain of the first gain block 201 is much saturated as the input power is increased. In this case, the pumping power of the Raman pump 205 should be adjusted to be lowered so that the Raman gain also represents a gentle gain slope, i.e., a second Raman gain slope ‘D’, thereby achieving the flat output gain spectrum by combining the second gain slope ‘C’ and the Raman gain slope

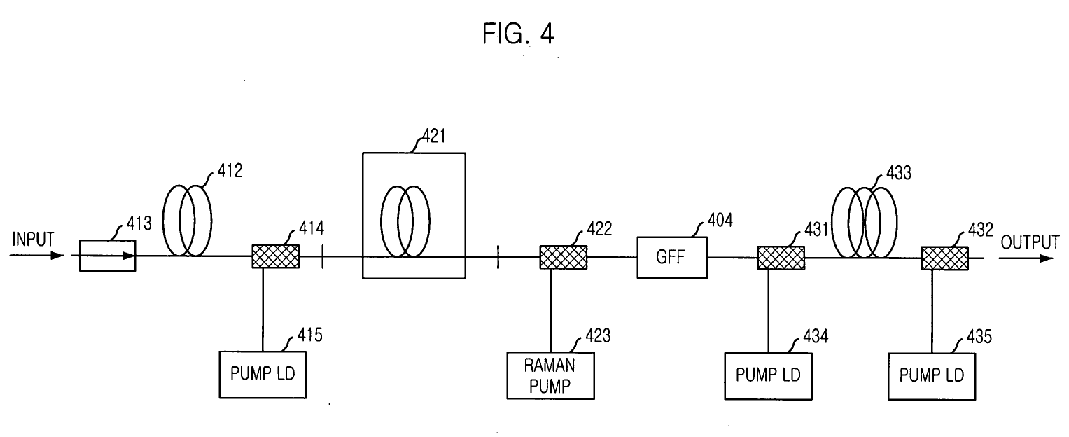

Referring to FIG. 4, there is shown a schematic view setting forth an optical fiber amplifier in accordance with a second preferred embodiment of the present invention.

In FIG. 4, the optical fiber amplifier includes an optical isolator 413 for enabling the optical signal to propagate forward and to cut off backward, a short length EDF 412 for amplifying an input optical signal, WDM couplers having a first, a second, a third and a fourth WDM coupler 414, 422, 431, 432 for coupling optical signals and pumping lights, a dispersion compensating fiber (DCF) 421 for compensating a dispersion in a transmission line, a Raman pump 423, a pump laser diodes (LD) having a first, a second and a third pump LD 415, 434, 435, a gain flattening filter 404 and a long length EDF 433.

In the optical fiber amplifier, an optical signal passing through the optical isolator 413 is transmitted to the short length EDF 412 and is coupled to a first pumping light generated at the first pump LD 415 through the first WDM coupler 414, to thereby amplify the optical signal. The optical signal amplified at the short length EDF 412 is inputted to the DCF 421 and is coupled to a second pumping light generated at the Raman pump 423 by means of the second WDM coupler 422. Herein, the Raman pump 423 has peak gain value at the final wavelength in the signal wavelength band like FIG. 3B. Between the second WDM coupler 422 and the third WDM coupler 431, the gain flattening filter 404 is disposed. Meanwhile, the long length EDF 433 is forwardly and backwardly pumped by the second and third pump LDs 434, 435 so that it is possible to obtain high output power.

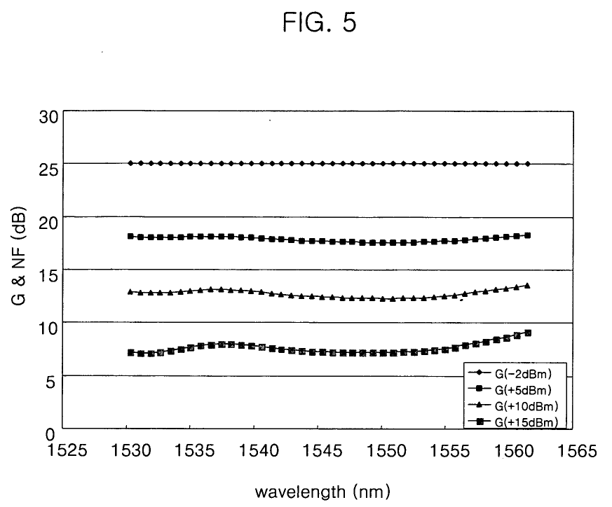

Referring to FIG. 5, there is shown a graph setting forth output gain spectrum across the signal wavelength band when the input power of the optical fiber amplifier having 40 channels is varied from −2 dBm to +15 dBm in accordance with the present invention.

In FIG. 5, when the input power is −2 dBm, the output gain profile shows flat gain, i.e., at the value of 25 dB, across the signal wavelength band and the output power is about +23 dBm. When the input power is increased to +5 dBm, the first, the second and the third pump LDs 415, 434, 435 are left intact and the Raman pump 423 is changed to have the gain slope like FIG. 3B, whereby the output gain profile becomes flat. In this case, the output power is also fixed to about +23 dBm. Like the same method, when the input power is increased to +10 dBm or +15 dBm, the Raman pump 423 is changed to have predetermined condition, to thereby obtain the flat output gain profile. Herein, it is possible to obtain a constant output power, i.e., +23 dBm, by changing the Raman pump 423 without changing the pump LDs 415, 434, and 435. In the graph, it is understood that the output gain profile shows a small deviation as the input power is increased higher. However, the deviation is tolerable because the deviation of the gain is within ±1 dB despite the input power of +15 dBm.

Meanwhile, when all the channels are transmitted in the optical fiber amplifier in which the DRA is employed, the input power is in the range of about +5 dBm to about +15 dBm. However, in case of not using the DRA in the transmission fiber, the input power is in a range of about −21 dBm to about −2 dBm because the input power may be varied due to a channel add/drop. Therefore, the present invention provides a broad input dynamic range, i.e., about 36 dB, to obtain the flat spectral gain profile.

As described above, there is employed the optical fiber between the first and the second gain blocks, wherein the first gain block and the optical fiber have opposite spectral gain profiles, to thereby obtain the flat gain profile despite the high input power. Accordingly, it is possible to achieve the broad input power dynamic range. As a result, when the input power of the line amplifier becomes higher by introducing the DRA to the optical transmission line, the fiber amplifier of the present invention is still available for the line amplifier because of the wide input power dynamic range.

While the present invention has been described with respect to the particular embodiments, it will be apparent to those skilled in the art that various changes and modifications may be made without departing from the scope of the invention as defined in the following claims.

1. An optical fiber amplifier comprising:
a first and a second gain blocks, wherein each gain block has a gain medium and at least one optical pump;
an optical fiber disposed between the first and the second gain blocks;
a Raman pump for generating a pumping light; and
a coupling means for coupling the pumping light to the optical fiber,
wherein the first gain block and the optical fiber have opposite gain profiles, to thereby offset gain characteristics each other and obtain a flat spectral gain profile.

2. The optical fiber amplifier as recited in claim 1, wherein the optical fiber employs a material selected from the group consisting of a dispersion compensated fiber (DCF), a highly non-linear fiber (HNLF), a single-mode fiber (SMF) and a combination thereof.

3. The optical fiber amplifier as recited in claim 1, further comprising a gain flattening filter in order to flatten gain characteristics.

4. The optical fiber amplifier as recited in claim 1, wherein the gain medium of the first gain block employs a rare earth doped optical fiber or a rare earth doped optical waveguide.

5. The optical fiber amplifier as recited in claim 1, wherein the gain medium of the second gain block employs a rare earth doped optical fiber or a rare earth doped waveguide.
